(19) United States
(12) Patent Application Publication
(10) Pub. No.: US 2012/0037018 A1
(43) Pub. Date: Feb. 16, 2012

(54) PATTERN TRANSFER DEVICE AND PATTERN TRANSFER METHOD

(75) Inventors: Min-Uk KIM, Seongnam-si (KR); Gug-Rae JO, Asan-si (KR); Joo-Han BAE, Suwon-si (KR)

(73) Assignee: SAMSUNG ELECTRONICS CO., LTD., Suwon-si (KR)

(21) Appl. No.: 13/074,619

(22) Filed: Mar. 29, 2011

(30) Foreign Application Priority Data
Aug. 10, 2010 (KR) 10-2010-0076908

(51) Int. Cl. B41F 5/00; B41F 3/34

(52) U.S. Cl. 101/216; 101/492

(57) ABSTRACT

Exemplary embodiments of the present invention disclose a pattern transfer device and a pattern transfer method. The pattern transfer device may include a printing plate stage to load a printing plate having a pattern of a predetermined shape, and a substrate stage to load a substrate on which the pattern formed on the printing plate is to be printed. The pattern transfer device also includes a pressure unit configured with the printing plate stage to apply pressure to the printing plate, and a printing unit to transfer the pattern formed on the printing plate to the substrate.

This application claims priority from and the benefit of Korean Patent Application No. 10-2010-0076908, filed on Aug. 10, 2010, which is hereby incorporated by reference for all purposes as if fully set forth herein.

### BACKGROUND OF THE INVENTION

1. Field of the Invention

Exemplary embodiments of the present invention relate to a pattern transfer device and a pattern transfer method.

2. Description of the Background

Electronic display devices play an increasingly important role in today's information society, and various kinds of electronic display devices are widely used in diverse industrial fields.

As semiconductor technology advances, there is an increasing demand for electronic devices with low driving voltage, low power consumption, light weight, and compact sizes. Accordingly, there is a need to fabricate slimmer and lighter flat panel display devices having low driving voltage and low power consumption. To fabricate flat panel display devices, a micro-pattern formation process may be required. A printing process has been increasingly used for the micro-pattern formation process.

### SUMMARY OF THE INVENTION

Exemplary embodiments of the present invention provide a pattern transfer device which can improve the flatness of a printing plate or a substrate when the printing plate or the substrate is loaded in the pattern transfer device.

Exemplary embodiments of the present invention also provide a pattern transfer method which improves the flatness of a printing plate or a substrate when the printing plate or the substrate is loaded in a pattern transfer device.

Additional features of the invention will be set forth in the description which follows, and in part will be apparent from the description, or may be learned by practice of the invention.

Exemplary embodiments of the present invention provide a pattern transfer device including a printing plate stage, a substrate stage, a pressure unit, and a printing unit. A printing plate including a pattern is disposed on the printing plate stage. A substrate is disposed on the substrate stage. The pattern formed on the printing plate is to be printed on the substrate. The pressure unit applies pressure to the printing plate. The pressure unit is disposed on the printing plate stage. The printing unit transfers the pattern formed on the printing plate to the substrate.

Exemplary embodiments of the present invention also provide a pattern transfer device including a printing plate stage, a substrate stage, a pressure unit, and a printing unit. A printing plate including a pattern is disposed on the printing plate stage. A substrate is disposed on the substrate stage. The pattern formed on the printing plate is to be printed on the substrate. The pressure unit applies pressure to the substrate. The pressure unit is disposed on the substrate stage. The printing unit transfers the pattern formed on the printing plate to the substrate.

Exemplary embodiments of the present invention also provide a pattern transfer method including disposing a printing plate on a printing plate stage. The printing plate includes a pattern. The method further includes measuring a flatness of the printing plate disposed on the printing plate stage, and changing, by using a pressure unit, the flatness of the printing plate by applying pressure to the printing plate disposed on the printing plate stage. The method further includes transferring, to a substrate, the pattern formed on the printing plate having a changed flatness.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a cross-sectional view of a pattern transfer device according to exemplary embodiments of the present invention.

FIG. 2 is a diagram illustrating a printing plate stage and a pressure unit according to exemplary embodiments of the present invention.

FIG. 3 is a diagram illustrating the process of loading a printing plate on the printing plate stage according to exemplary embodiments of the present invention.

FIG. 4 is a diagram illustrating the relationship between the pressure unit and the flatness profiles and regions of the printing plate according to exemplary embodiments of the present invention.

FIG. 5 is a diagram illustrating the operation of the pressure unit according to exemplary embodiments of the present invention.

FIG. 6 is a flowchart illustrating a pattern transfer method according to exemplary embodiments of the present invention.

FIG. 7 and FIG. 8 are diagrams illustrating flatness measuring devices which measure the flatness of a printing plate according to exemplary embodiments of the present invention.

FIG. 9, FIG. 10, FIG. 11, FIG. 12, and FIG. 13 are diagrams illustrating the process of transferring patterns formed on the printing plate to a substrate according to exemplary embodiments of the present invention.

FIG. 14 is a cross-sectional view of a pattern transfer device according to exemplary embodiments of the present invention.

FIG. 15 is a diagram illustrating a printing plate stage and a pressure unit according to exemplary embodiments of the present invention.

FIG. 16 is a diagram illustrating the relationship between the pressure unit and the flatness profiles and regions of a substrate according to exemplary embodiments of the present invention.

FIG. 17 is a diagram illustrating the operation of the pressure unit according to exemplary embodiments of the present invention.

### DETAILED DESCRIPTION OF THE ILLUSTRATED EMBODIMENTS

Advantages and features of exemplary embodiments of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art. In the drawings, the size and relative sizes of layers and regions may be exaggerated for clarity. Like reference numerals in the drawings refer to like elements throughout the specification.

It will be understood that when an element or layer is referred to as being “on” another element or layer, the element or layer can be directly on another element or layer or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the drawings. It will be understood that the spatially relative terms are intended to encompass different orientations of the device in use or operation, in addition to the orientation depicted in the drawings.

Exemplary embodiments of the invention are described herein with reference to plan and cross-section illustrations that are schematic illustrations of exemplary embodiments of the invention. As such, variations from the shapes of the illustrations as a result, for example, of manufacturing techniques and/or tolerances, are to be expected. Thus, exemplary embodiments of the invention should not be construed as limited to the particular shapes of regions illustrated herein but are to include deviations in shapes that result, for example, from manufacturing. Thus, the regions illustrated in the drawings are schematic in nature and their shapes do not necessarily illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a packet transfer device and a pattern transfer method according to exemplary embodiments of the present invention will be described with reference to the attached drawings.

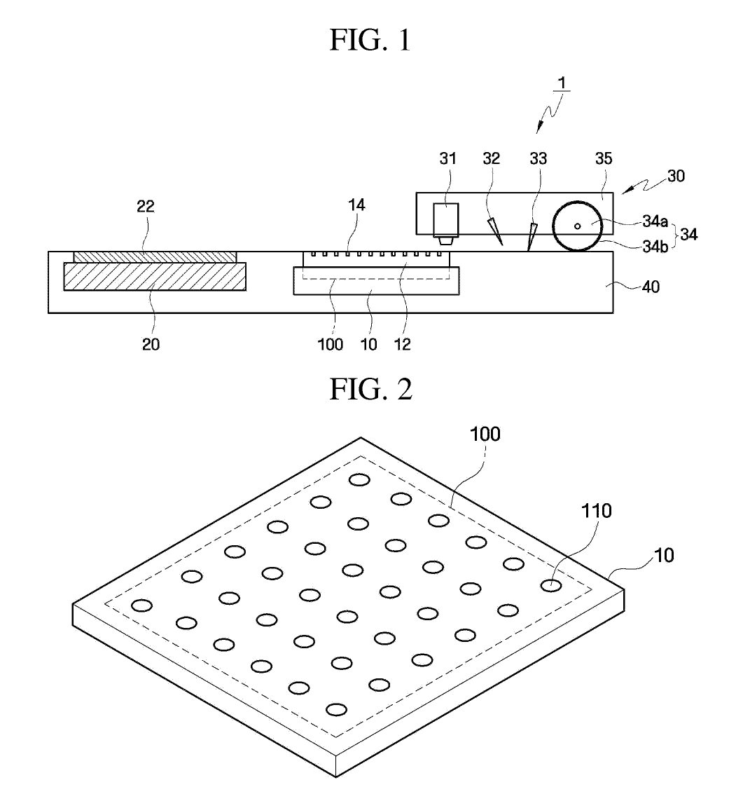

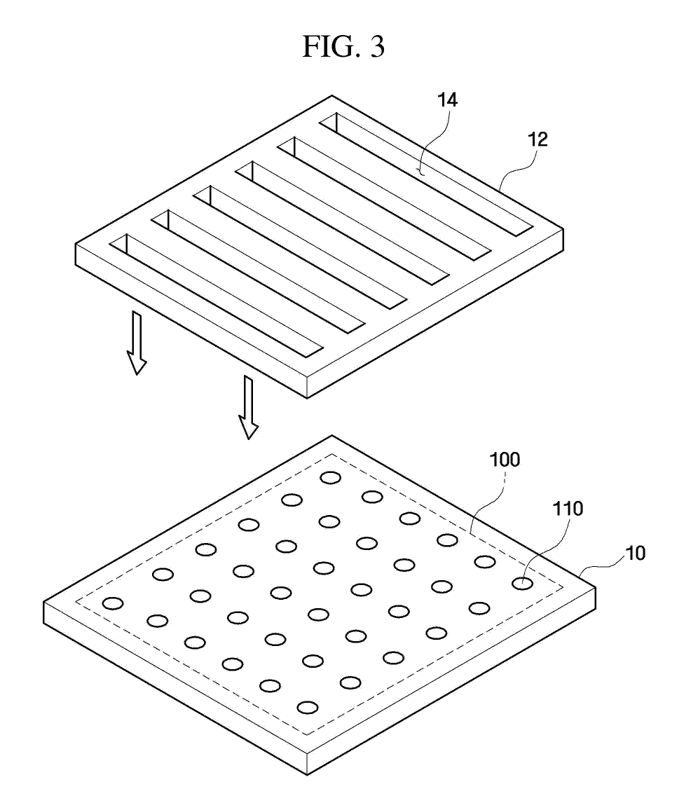

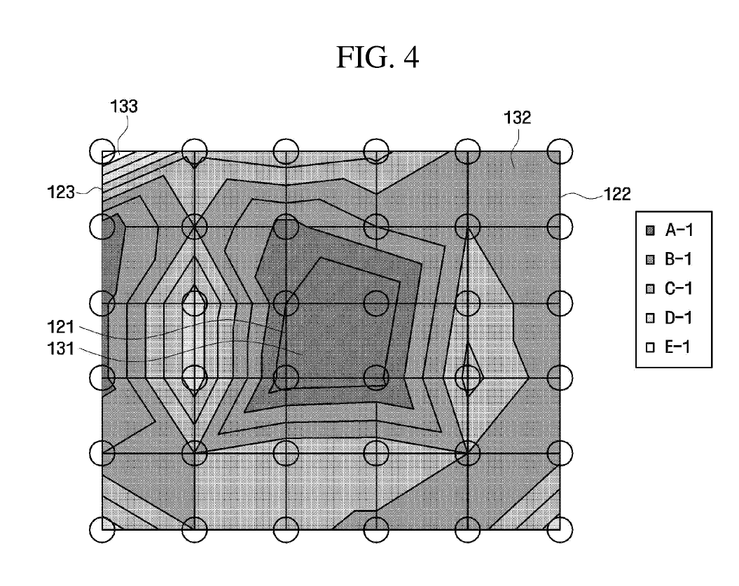

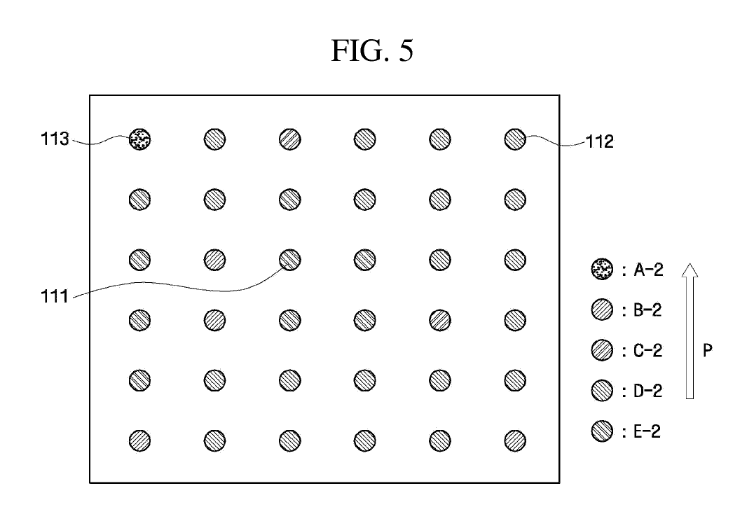

A pattern transfer device according to exemplary embodiments of the present will now be described with reference to FIG. 1, FIG. 2, FIG. 3, FIG. 4, and FIG. 5.

FIG. 1 is a cross-sectional view of a pattern transfer device 1 according to exemplary embodiments of the present invention. FIG. 2 is a diagram illustrating a printing plate stage 10 and a pressure unit 100. FIG. 3 is a diagram illustrating the process of loading a printing plate 12 on the printing plate stage 10. FIG. 4 is a diagram illustrating the relationship between the pressure unit 100 and the flatness profiles and regions of the printing plate 12. FIG. 5 is a diagram illustrating an operation of the pressure unit 100.

Referring to FIG. 1, the pattern transfer device 1 may include the printing plate stage 10, a substrate stage 20, the pressure unit 100, and a printing unit 30.

The printing plate 12, on which patterns of a predetermined shape may be formed, may be loaded on a top surface of the printing plate stage 10. The printing plate stage 10 may include a printing plate fixing unit (not shown) which fixes the printing plate 12 in place in order to prevent the movement of the printing plate 12 during a process. In general, the printing plate stage 10 may be a platform on which the printing plate 12 is affixed or hosted for applying a programmed pattern on to the printing plate 12.

The printing plate 12 loaded on the top surface of the printing plate stage 10 may have predetermined patterns which are to be transferred to a substrate 22. The printing plate 12 may be any suitable shape, including for example, a rectangular shape (e.g., a plate-shape). The printing plate 12 may be replaced for a pattern transfer process. When the pattern transfer process is performed successively, the printing plate 12 fixed onto the printing plate stage 10 can be used continuously. In general, the printing plate 12 may be made of any suitable material. For example, in some cases, the printing plate 12 may be made of an insulator such as glass.

The substrate stage 20 may be separated from the printing plate stage 10 by a predetermined gap and may be placed parallel to the printing plate stage 10, as shown in FIG. 1. In general, the substrate stage 20 may be a platform on which the substrate 22 is affixed or hosted. The substrate 22 may be mounted on the substrate stage 20. A height of the substrate stage 20 may be adjusted such that a top surface of the printing plate 12 is at substantially the same height as a top surface of the substrate 22 loaded on the substrate stage 20. The substrate 22 may be made of any suitable material, and in some cases, may be a substrate used to make a flat panel display.

The substrate stage 20 and the printing plate stage 10 may be fixed and coupled to a main frame 40 such that the positions of the substrate stage 20 and the printing plate stage 10 remain unchanged during a pattern transfer process. During preparation for the pattern transfer process, the positions of the substrate stage 20 and the printing plate stage 10 on the main frame 30 can be changed. However, once the substrate stage 20 and the printing plate stage 10 are fixed at specific positions on the main frame 40, the substrate stage 20 and the printing plate stage 10 may be coupled to the main frame 40 such that they cannot move during a process. In general, the main frame 40 may be any suitable housing unit for housing the printing plate stage 10 and the substrate stage 20.

The printing unit 30 may transfer patterns formed on the printing plate 12 to the substrate 22 and may shuttle between the printing plate stage 20 and the substrate stage 10. The printing unit 30 may include an input supply unit 31, an ink-filling blade 32, a remaining ink-removing blade 33, a transfer roll 34, a housing 35, and a horizontal movement unit (not shown). Movement of the printing unit 30 may be controlled by the horizontal movement unit, as described in further detail below.

The ink supply unit 31 may supply a predetermined amount of ink onto the top surface of the printing plate 12 loaded on the printing plate stage 10. The ink supply unit 31 can supply ink to any position on the printing plate 12. In some cases, as shown in FIG. 1, the ink supply unit 31 may supply ink onto a front end of the printing plate 12 so as to facilitate a subsequent ink-filling process. The amount of ink supplied to the printing plate 12 may vary based on the type of printing plate 12. In general, any necessary amount of ink may be provided on the printing plate 12.

The ink-filling blade 32 may fill pattern grooves 14 formed on the top surface of the printing plate 12 with ink. In general, the ink-filling blade 32 may be any suitable shape or length. In some cases, the ink-filling blade 32 may have a length corresponding to a width of the printing plate 12. The ink-filling blade 32 may be separated from the top surface of the printing plate 12 by a predetermined gap. The ink-filling blade 32 may move horizontally and may disperse ink, which is applied onto the top surface of the printing plate 12 by the ink supply unit 31, over the top surface of the printing plate 12 according to a predetermined thickness. In some cases, the ink may be evenly spread over the top surface of the printing plate 12, and the pattern grooves 14 formed on the top surface of the printing plate 12 may be filled with the ink.

The remaining ink-removing blade 33 may remove ink that remains after filling the pattern grooves 14 from the top surface of the printing plate 12. The remaining ink-removing blade 33 may have any suitable shape, and, in some cases, may have a shape similar to that of the ink-filling blade 32. However, the position of the remaining ink-removing blade 33 may be different from that of the ink-filling blade 32. While the ink-filling blade 32 is separated from the top surface of the printing plate 12 by a predetermined gap, the remaining ink-removing blade 33 may contact the top surface of the printing plate 12. Therefore, the remaining ink-removing blade 33 can remove ink that remains after filling the pattern grooves 14 of the printing plate 12 from the top surface of the printing plate 12.

To fill the pattern grooves 14 with ink, the ink-filling blade 32 may be installed such that its top end tilts in a direction in which the ink-filling blade 32 moves horizontally, as shown in FIG. 1. On the other hand, to remove ink, the remaining ink-removing blade 33 may be installed such that its top end tilts in a direction opposite to a direction in which the remaining ink-removing blade 33 moves horizontally.

The transfer roll 34 may rotate when in contact with the top surface of the printing plate 12 or the main frame 40. Ink filling the pattern grooves 14 may be transferred to a surface of the transfer roll 34 when the transfer roll 34 rotates on the printing plate 12. The transfer roll 34 may then print the transferred ink on the top surface of the substrate 22. As shown in FIG. 1, the transfer roll 34 may include a cylindrical roller 34a surrounded by a blanket 34b having a predetermined thickness. The blanket 34b may be a type of cover and may wrap around a surface of the roller 34a. The blanket 34b may be made of a material to which ink that fills the pattern grooves 14 of the printing plate 12 can be easily attached. In addition, the blanket 34b may have some elasticity to be able to easily contact ink that fills the pattern grooves 14 of the printing plate 12.

The housing 35 may accommodate the ink supply unit 31, the ink-filling blade 32, the remaining ink-filling blade 33, and the transfer roll 34. Accordingly, the housing 35 can integrate the ink supply unit 31, the ink-filling blade 32, the remaining ink-removing blade 33, and the transfer roll 34.

The horizontal movement unit (not shown) may horizontally move the housing 35. As the horizontal movement unit horizontally moves the housing 35, elements installed within the housing 35 may also move horizontally. The printing unit 30 may move in a predetermined direction (hereinafter, referred to as a ‘printing direction’), for example, moving from above the printing plate 12 to above the substrate 22 in the process of filling the printing plate 12 with ink and transferring the patterns on the substrate 22. Accordingly, the horizontal movement unit may move the printing unit 30 horizontally to perform a process.

A printing unit aligner (not shown) may horizontally move the printing unit 30 in a direction (hereinafter, referred to as an ‘alignment direction’) perpendicular to a direction in which the printing plate stage 10 and the substrate stage 20 are arranged. Movement along the alignment direction may facilitate determining a position on the substrate to which a pattern is to be transferred.

Referring to FIG. 2, FIG. 3, FIG. 4, and FIG. 5, the pressure unit 100 may include a plurality of pressure members 110 to locally apply pressure to the printing plate 12. The plurality of pressure members 110 may be arranged in any suitable manner. For example, in some cases, the plurality of pressure members 110 may be arranged in a grid-like formation and each pressure member 110 may be equally spaced from one-another, as shown in FIG. 2. In some cases, the distance between various pressure members 110 may vary. To apply pressure to the printing plate 12, the pressure unit 100 may be configured with the printing plate stage 10 on which the printing plate 12 is loaded. For example, in some cases, the pressure unit 100 may be integrated with the printing plate stage 10, and, in some cases, the pressure unit 100 may be attached to the printing plate stage 10 in any suitable manner.

In some cases, the printing plate 12 may be loaded on the printing plate stage 10 to overlap the pressure unit 100. The pressure unit 100 may be driven in a direction from the top surface of the printing plate stage 10, on which the printing plate 12 is placed, to the printing plate 12, so that the pressure members 110 of the pressure unit 100 can deliver pressure to the printing plate 12. The pressure members 110 may be, for example, pressure bars or pressure pins. Accordingly, each of the pressure pins may be driven in the direction from the printing plate stage 10 to the printing plate 12, thereby applying a predetermined pressure to the printing plate 12.

While the printing plate 12 may be plate-shaped, the printing plate 12 may not always have uniform flatness across its entire surface. There are various reasons for this. For example, the surface of the printing plate 12 may be partially bent or curved when the printing plate 12 is formed, or different external forces may be applied locally to the surface of the printing plate 12 when the printing plate 12 is loaded on the printing plate stage 10.

Referring to FIG. 4, the printing plate 12 may have a plurality of flatness profiles for the above-mentioned reasons. In addition, a plurality of regions may be defined in the printing plate 12 to correspond to the various flatness profiles, respectively. The number of the regions of the printing plate 12 may correspond to the number of the pressure members 110 of the pressure unit 100 so that a different pressure can be applied to each region of the printing plate 12 according to the flatness of each region.

In FIG. 4, reference numeral 131 indicates a first flatness profile, reference numeral 132 indicates a second flatness profile, and reference numeral 133 indicates a third flatness profile. In addition, reference numeral 121 indicates a first region having the first flatness profile 131, reference numeral 122 indicates a second region having the second flatness profile 132, and reference numeral 123 indicates a third region having the third flatness profile 133.

Reference characters A-1 through E-1 indicate the difference in surface height according to the flatness profile of the printing plate 12. The surface height of the printing plate 12 increases in the order of E-1 to A-1. For example, the surface height E-1 of the printing plate 12 is relatively lower than the surface height A-1 of the printing plate 12, which is the highest surface height of the various surface heights. The surface height of the printing plate 12 can be defined as the distance from the printing plate stage 10 to the top surface of the printing plate 12 not contacting the printing plate stage 10.

The first through third regions 121 through 123 correspond to the first through third flatness profiles 131 through 133, respectively. The pressure unit 100 may apply different pressures to the first through third regions 121 through 123 in order to improve the flatness profile of the printing plate 12. Accordingly, the pressure unit 100 may include the plurality of pressure members 110 to correspond to the first through third regions 121 through 123, respectively. For example, the pressure unit 100 may include a first pressure member 111 to apply pressure to the first region 121, a second pressure member 112 to apply pressure to the second region 122, and a third pressure member 113 to apply pressure to the third region 123 (see FIG. 5). Each of the first through third pressure members 111 through 113 may be independently driven by a pressure member driver (not shown). Accordingly, the first through third pressure members 111 through 113 may apply different pressures to the first through third regions 121 through 123, respectively, according to the flatness profiles of the first through third regions 121 through 123, respectively. Pressure from the first through third pressure members 111 through 113 may be applied to the printing plate 12 in any suitable direction including, for example, a direction from the printing plate stage 10 to the printing plate 12.

As noted above, the surface height A-1 of the first region 121 of the printing plate 12 may be higher than the surface height B-1 of the second region 122 of the printing plate 12 and the surface height B-1 of the second region 122 of the printing plate 12 may be higher than the surface height C-1 of the third region 123 of the printing plate 12. After applying pressure through the pressure members 110, the flatness of the printing plate 12 may improve. For example, in some cases, the flatness of the first region 121, the second region 122, and the third region 123 may be the same after having pressure applied. In some cases, the differences between the flatness of the first region 121, the second region 122, and the third region 123 may be reduced after having pressure applied.

In FIG. 5, reference characters A-2 through E-2 sequentially indicate magnitudes of pressure P applied to the printing plate 12 by the pressure members 110. The magnitude of pressure P applied to the printing plate 12 may increase in the order of E-2 to A-2. For example, the magnitude E-2 of the pressure P applied to the printing plate 12 may be the smallest, whereas the magnitude A-2 of the pressure P may be greatest.

Referring to FIG. 4 and FIG. 5, since the surface height of the first region 121 is the highest, the magnitude E-2 of the pressure P applied to the first region 121 by the first pressure member 111 may be the smallest relative to the magnitudes (e.g., A-2 to D-2) of the applied pressure P. In addition, since the surface height of the second region 122 is relatively lower than the surface height of the first region 121, the magnitude D-2 of the pressure P applied to the second region 122 by the second pressure member 112 may be relatively greater than the magnitude E-2 of the pressure P applied to the first region 121. Furthermore, since the surface height of the third region 123 is relatively lower than the surface height of the second region 122, the magnitude A-2 of the pressure P applied to the third region 123 by the third pressure member 113 may be relatively greater than the magnitude D-2 of the pressure P applied to the second region 122. As illustrated by FIG. 4 and FIG. 5, a greater pressure may be applied to regions having a lower surface height. Similarly, a smaller pressure may be applied to regions having a higher surface height.

While the first through third regions 121 through 123 have been described as exemplary regions of the printing plate 12, the printing plate 12 may include a plurality of regions as shown in FIG. 4 and FIG. 5. In addition, the pressure unit 100 may include the plurality of pressure members 110. Therefore, the pressure members 110 of the pressure unit 100 may also apply pressure to regions of the printing plate 12 other than the above-described first through third regions 121 through 123. Accordingly, the flatness of the entire surface of the printing plate 12 can be improved. Consequently, the printing plate 12 having the improved flatness enables the pattern transfer device 1 to precisely transfer patterns onto the substrate 22.

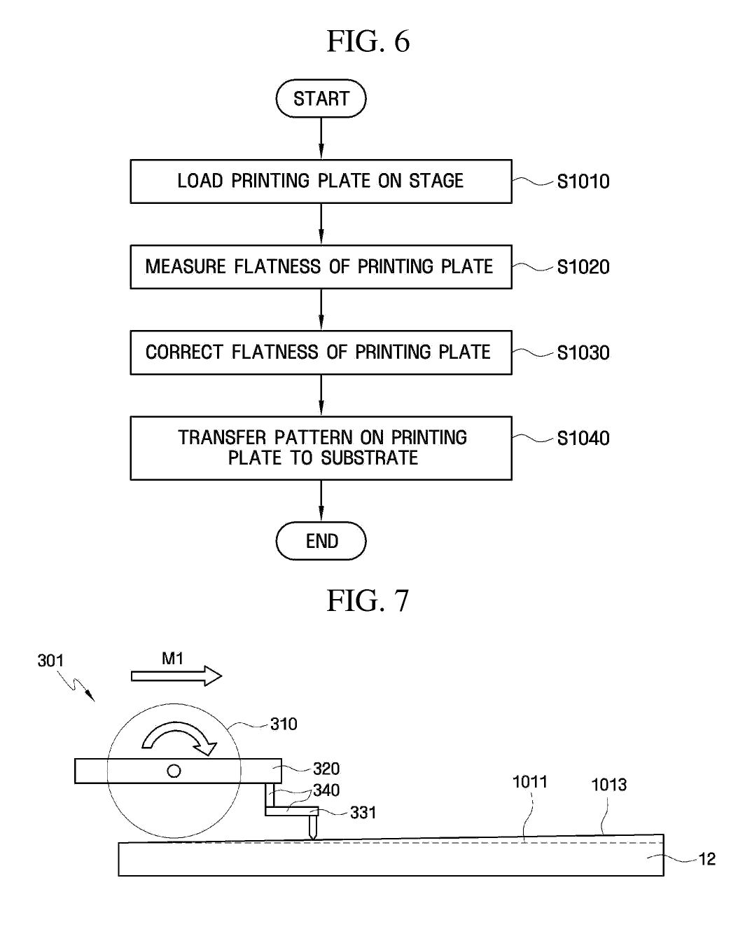

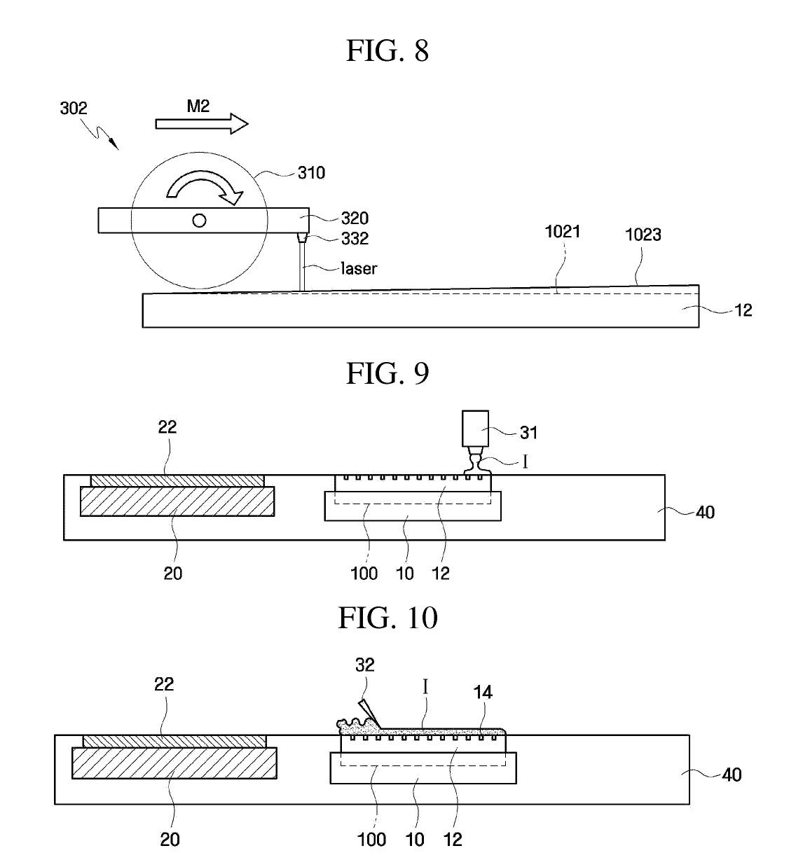

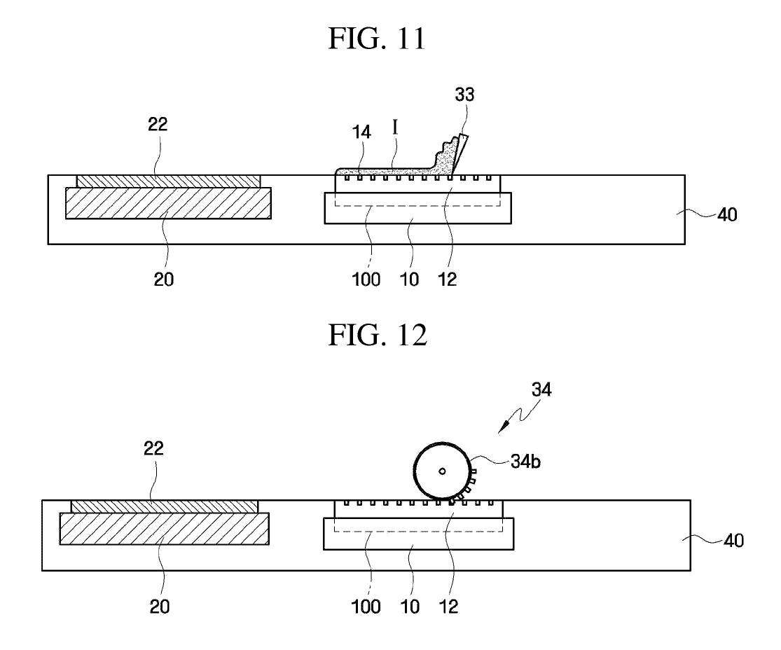

A pattern transfer method according to exemplary embodiments of the present invention will now be described with reference to FIG. 1, FIG. 4, FIG. 5, FIG. 6, FIG. 7, FIG. 8, FIG. 9, FIG. 10, FIG. 11, FIG. 12, and FIG. 13.

FIG. 6 is a flowchart illustrating a pattern transfer method according to exemplary embodiments of the present invention. FIG. 7 and FIG. 8 are diagrams illustrating flatness measuring devices 301 and 302, which measure the flatness of a printing plate 12. FIG. 9, FIG. 10, FIG. 11, FIG. 12, and FIG. 13 are diagrams illustrating the process of transferring patterns formed on the printing plate 12 to a substrate 22.

Referring to FIG. 1, FIG. 3, and FIG. 6, the printing plate 12 on which predetermined patterns 14 are formed may be loaded on a printing plate stage 10 (S1010). The printing plate 12 may be loaded on the printing plate stage 10 to overlap a pressure unit 100, which is configured with the printing plate stage 10.

Next, a flatness of the printing plate 12 loaded on the printing plate stage 10 may be measured (S1020). Accordingly, the flatness profiles of the printing plate 12 are defined, and a plurality of regions 120 may be defined in the printing plate 12 to correspond respectively to a plurality of pressure members 110 of the pressure unit 100.

FIG. 7 illustrates one example of a flatness measuring device. Referring to FIG. 7, the flatness of the printing plate 12 may be measured by the flatness measuring device 301. The flatness measuring device 301 may include a blanket roll 310, a blanket carriage 320, a probe 331, and a probe support 340 which fixes the probe 331 to the blanket carriage 320. When the blanket roll 310 moves in a first direction M1, the flatness measuring device 301 may measure the flatness of the printing plate 12 by using the probe 331 installed on the blanket carriage 320. To measure the flatness of the printing plate 12, the probe 331 may contact a surface 1013 of the printing plate 12 and obtain a measurement of the flatness of surface 1013. The flatness measuring device 301 may then calculate a difference in height between an ideal surface 1011 of the printing plate 12 for pattern formation and surface 1013 of the printing plate 12 loaded on the printing plate stage 10, and may determine the flatness profiles of the printing plate 12 based on the calculated difference.

FIG. 8 illustrates another example of a flatness measuring device. The flatness measuring device 302, illustrated in FIG. 8, may measure the flatness of the printing plate 12 by using a laser sensor 332, instead of the probe 331. For example, the flatness measuring device 302 may emit a laser beam using the laser sensor 332, and may measure the time taken for the emitted laser beam to return after contacting each region of the surface 1013 of the printing plate 12. The measured time may vary according to surface characteristics of the printing plate 12. For example, a measured time for a laser beam emitted towards a region of the surface 1013 of the printing plate 12 that is relatively close to the laser sensor 332 is shorter than a measured time for a laser beam emitted towards a region of the surface 1013 of the printing plate 12 that is relatively far from the laser sensor 332. Based on measured data, the flatness measuring device 302 may determine the flatness profiles of the printing plate 12 loaded on the printing plate stage 10. In general, various types of laser beams and/or detectors may be used to determine the flatness of the printing plate 12.

Once the flatness profiles of the printing plate 12 are determined, the surface 1013 of the printing plate 12 may be divided into a plurality of regions, so that pressure can be applied locally to the printing plate 12 by the pressure members 110 of the pressure unit 100.

Next, the flatness of the printing plate 12 may be corrected based on the determined flatness profiles (S 1030). A method of correcting the flatness of the printing plate 12 may be the same as described above, and thus a redundant description thereof is omitted.

Referring to FIG. 9, FIG. 10, FIG. 11, FIG. 12, and FIG. 13, the patterns 14 formed on the printing plate 12 having the corrected flatness may be transferred to the substrate 22 (S1040).

Referring to FIG. 9, an ink supply unit 31 may be driven to apply a predetermined amount of ink I to a top surface of the printing plate 12. The amount of ink I applied by the ink supply unit 40 may be more than enough to cover the entire top surface of the printing plate 12. In general, any suitable amount of ink I may be applied to the top surface of the printing plate 12. Ink I may be applied on any location of the printing plate 12, including, for example, an end of the printing plate 12. When ink I is applied to a position in the middle of the printing plate 12, the number of horizontal movements of an ink-filling blade 32 may increase, thereby increasing processing time.

Referring to FIG. 10, ink I supplied to the top surface of the printing plate 12 may be evenly spread over the entire top surface of the printing plate 12 by the ink-filling blade 32, so that each pattern 14 formed on the top surface of the printing plate 12 can be completely filled with ink I. The ink-filling blade 32, which is separated from the printing plate 12 by a predetermined gap, may spread the ink I over the entire top surface of the printing plate 12 by pushing the ink I in any suitable direction, including, for example, a downward direction and/or a horizontal direction.

Referring to FIG. 11, ink I remaining on the top surface of the printing plate 12 after filling the pattern grooves 14 may be removed using a remaining ink-removing blade 33. Ink I that fills the pattern grooves 14 may form patterns on the substrate 22 after a transfer process and a printing process is completed. However, ink I remaining in regions other than the pattern grooves may be printed on the substrate 22 by a transfer roll 34 to form unwanted patterns. For this reason, the remaining ink I must be completely removed.

Referring to FIG. 12, the transfer roll 34 may rotate when in contact with the top surface of the printing plate 12, which may be completely or partially filled with ink I. Accordingly, a transfer process is performed. For example, ink I that fills the patterns 14 on the top surface of the printing plate 12 may be transferred to a surface of a blanket 34b. The patterns 14 formed on the printing plate 12 should be transferred to the blanket 34b with no change in the size of the patterns 14 and the gap between the patterns 14. Therefore, the rotation speed and horizontal movement speed of the transfer roll 34 must be controlled with great precision.

Referring to FIG. 13, after traversing the predetermined distance between the printing plate 12 and the substrate 22, the transfer roll 34 may contact a top surface of the substrate 22 to print ink I, which has been transferred to the transfer roll 34, on the top surface of the substrate 22. In some cases, since the flatness of the printing plate 12 is corrected to be uniform across the entire surface of the printing plate 12, the transfer process can be performed in a stable and precise manner.

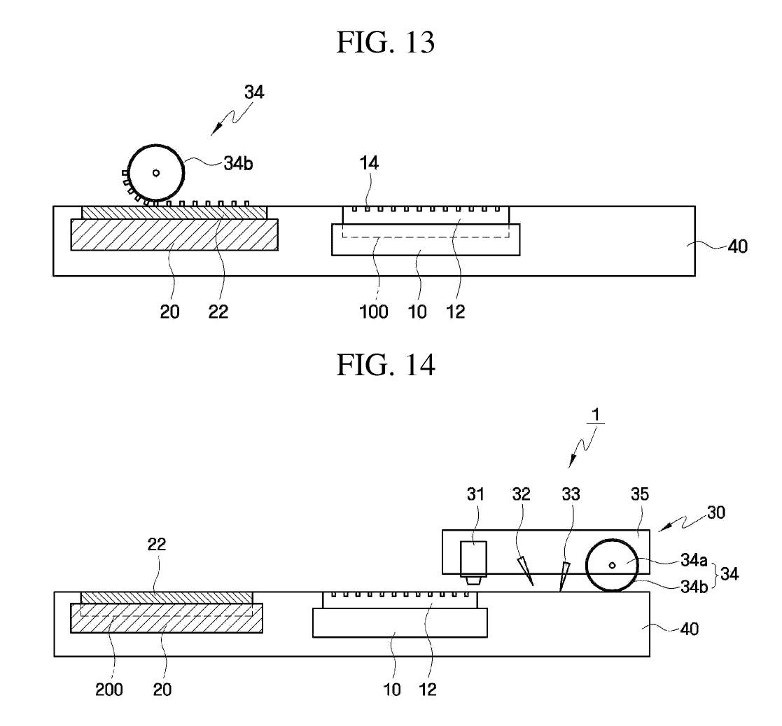

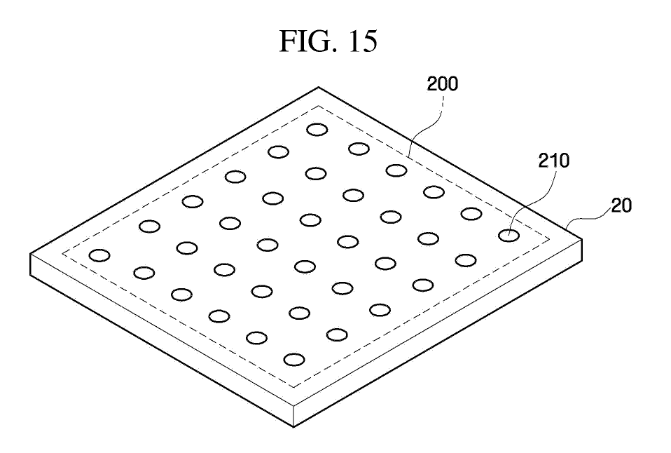

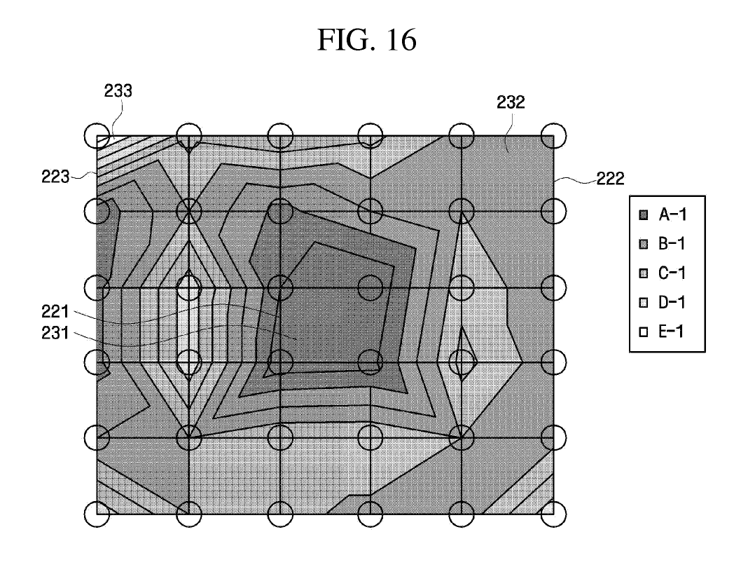

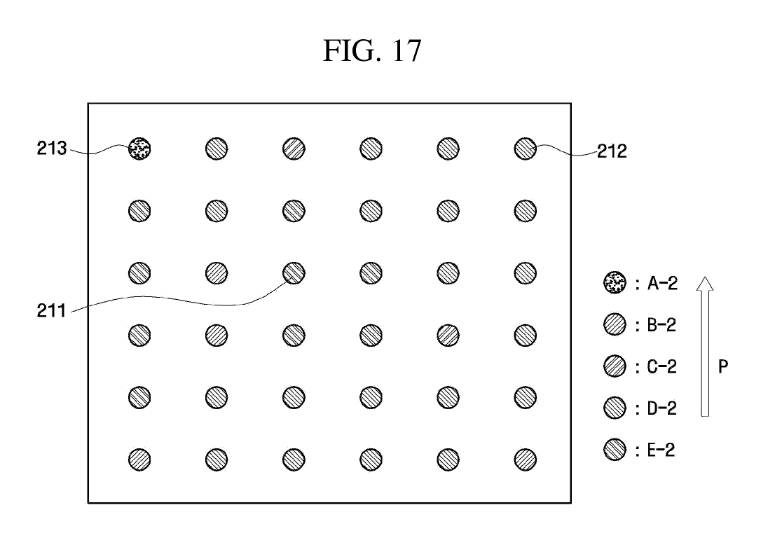

A pattern transfer method according to exemplary embodiments of the present invention will now be described with reference to FIG. 14, FIG. 15, FIG. 16, and FIG. 17.

FIG. 14 is a cross-sectional view of a pattern transfer device 2 according to exemplary embodiments of the present invention. FIG. 15 is a diagram illustrating a printing plate stage 20 and a pressure unit 200. FIG. 16 is a diagram illustrating the relationship between the pressure unit 200 and the flatness profiles and regions of a substrate 22. FIG. 17 is a diagram illustrating the operation of the pressure unit 200. Elements having the same functions as those described with reference to FIG. 1, FIG. 2, FIG. 3, FIG. 4, FIG. 5, FIG. 6, FIG. 7, FIG. 8, FIG. 9, FIG. 10, FIG. 11, FIG. 12, and FIG. 13 are indicated by like reference numerals, and thus their description will be omitted.

Referring to FIG. 14, the pattern transfer device 2 may include a printing plate stage 10, the substrate stage 20, the pressure unit 200, and a printing unit 30.

Referring to FIG. 14, FIG. 15, FIG. 16, and FIG. 17, the pressure unit 200 may include a plurality of pressure members 210 to locally apply pressure to the substrate 22. To apply pressure to the substrate 22, the pressure unit 200 may be installed with the substrate stage 20 on which the substrate 22 is loaded.

The substrate 22 may be loaded on the substrate stage 20 to overlap the pressure unit 200. The pressure members 210 of the pressure unit 200 may be driven in any suitable direction, including, for example, a direction from a top surface of the substrate stage 20, on which the substrate 22 is placed, to the substrate 22, so that the pressure members 210 can deliver pressure to the substrate 22. The pressure members 110 may be, for example, pressure bars or pressure pins.

While the substrate 22 may be plate-shaped, the substrate 22 may not always have uniform flatness across its entire surface due to a variety of reasons. For example, the surface of the substrate 22 may be partially bent or curved when the substrate 22 is formed, or different external forces may be applied locally to the surface of the substrate 22 when the substrate 22 is loaded on the printing plate stage 10.

Referring to FIG. 16, the substrate 22 may have a plurality of flatness profiles for the above-mentioned reasons. In addition, a plurality of regions may be defined in the substrate 22 to correspond to the flatness profiles, respectively. The number of the regions of the substrate 22 may correspond to the number of the pressure members 210 of the pressure unit 200, so that a different pressure may be applied to each region of the substrate 22 according to the flatness of each region.

In FIG. 16, reference numeral 231 indicates a first flatness profile, reference numeral 232 indicates a second flatness profile, and reference numeral 233 indicates a third flatness profile. In addition, reference numeral 221 indicates a first region having the first flatness profile 231, reference numeral 222 indicates a second region having the second flatness profile 232, and reference numeral 223 indicates a third region having the third flatness profile 233.

Reference characters A-1 through E-1 in FIG. 16 indicate the difference in surface height according to the flatness profile of the substrate 22. The surface height of the substrate 22 increases in the order of E-1 to A-1. For example, the surface height E-1 of the substrate 22 is relatively lower than the surface height A-1 of the substrate 22, which is the highest surface height of the various surface heights. The surface height of the substrate 22 can be defined as the distance from the substrate stage 20 to the top surface of the substrate 22 not contacting the substrate stage 20.

The first through third regions 221 through 223 correspond to the first through third flatness profiles 231 through 233, respectively. The pressure unit 200 may apply different pressures to the first through third regions 221 through 223 in order to improve the flatness profile of the substrate 22. Accordingly, the pressure unit 200 may include the plurality of pressure members 210 to correspond to the first through third regions 221 through 223, respectively. For example, the pressure unit 200 may include a first pressure member 211 to apply pressure to the first region 221, a second pressure member 212 to apply pressure to the second region 222, and a third pressure member 213 to apply pressure to the third region 223 (see FIG. 17). Each of the first through third pressure members 211 through 213 may be independently driven by a pressure member driver (not shown). Accordingly, the first through third pressure members 211 through 213 may apply different pressures to the first through third regions 221 through 223, respectively, according to the flatness profiles of the first through third regions 221 through 223, respectively. Pressure from the first through third pressure members 211 through 213 may be applied to the substrate 22 in any suitable direction including, for example, a direction from the substrate stage 20 to the substrate 22.

For example, as noted above, the surface height A-1 of the first region 221 of the substrate 22 may be higher than the surface height B-1 of the second region 222 of the substrate 22 and the surface height B-1 of the second region 222 of the substrate 22 may be higher than the surface height C-1 of the third region 223 of the substrate 22. After applying pressure through the pressure members 210, the flatness of the substrate 22 may improve. For example, in some cases, the flatness of the first region 221, the second region 222, and the third region 223 may be the same after having pressure applied. In some cases, the differences between the flatness of the first region 121, the second region 122, and the third region 223 may be reduced after having pressure applied.

In FIG. 17, reference characters A-2 through E-2 sequentially indicate magnitudes of pressure P applied to the substrate 22 by the pressure members 210. The magnitude of pressure P applied to the substrate 22 may increase in the order of E-2 to A-2. For example, the magnitude E-2 of the pressure P applied to the substrate 22 may be the smallest, whereas the magnitude A-2 of the pressure P may be the greatest.

Referring to FIG. 16 and FIG. 17, since the surface height of the first region 221 is the highest, the magnitude E-2 of the pressure P applied to the first region 221 by the first pressure member 211 may be smallest relative to the magnitudes (e.g., A-2 to D-2) of the applied pressure P. In addition, since the surface height of the second region 222 is relatively lower than the surface height of the first region 221, the magnitude D-2 of the pressure P applied to the second region 222 by the second pressure member 212 may be relatively greater than the magnitude E-2 of the pressure P applied to the first region 221. Furthermore, since the surface height of the third region 223 is relatively lower than the surface height of the second region 222, the magnitude A-2 of the pressure P applied to the third region 223 by the third pressure member 213 may be relatively greater than the magnitude D-2 of the pressure P applied to the second region 222. As illustrated by FIG. 16 and FIG. 17, a greater pressure may be applied to regions having a lower surface height. Similarly, a smaller pressure may be applied to regions having a higher surface height.

While the first through third regions 221 through 223 have been described as exemplary regions of the substrate 22, the substrate 22 may include a plurality of regions as shown in FIGS. 16 and 17. In addition, the pressure unit 200 may include the plurality of pressure members 210. Therefore, the pressure members 210 of the pressure unit 200 may also apply pressure to regions of the substrate 22 other than the above-described first through third regions 221 through 223. Accordingly, the flatness of the entire surface of the substrate 22 can be improved. Consequently, the substrate 22 having the improved flatness enables the pattern transfer device 2 to precisely transfer patterns onto the substrate 22.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A pattern transfer device, comprising:
a printing plate stage on which a printing plate comprising a pattern is disposed;
a substrate stage on which a substrate is disposed, the pattern formed on the printing plate is to be printed on the substrate;
a pressure unit to apply pressure to the printing plate, the pressure unit being disposed on the printing plate stage; and
a printing unit to transfer the pattern formed on the printing plate to the substrate.

2. The pattern transfer device of claim 1, wherein the substrate stage is separated from the printing plate stage by a gap, and wherein the printing plate comprises at least one region having at least one flatness profile, respectively, and the pressure unit applies pressure to each of the at least one region of the printing plate.

3. The pattern transfer device of claim 2, wherein the pressure unit comprises a plurality of pressure members configured to deliver pressure to the at least one region of the printing plate, respectively.

4. The pattern transfer device of claim 3, wherein the at least one region of the printing plate comprises a first region having a first flatness profile, a second region having a second flatness profile, and a third region having a third flatness profile, each of the first flatness profile, the second flatness profile, and the third flatness profile has a different flatness profile, and the pressure unit applies a different pressure to each of the first region, the second region, and the third region.

5. The pattern transfer device of claim 4, wherein the pressure members comprise a first pressure member to apply pressure to the first region, a second pressure member to apply pressure to the second region, and a third pressure member to apply pressure to the third region, wherein the first pressure member, the second pressure member, and the third pressure member apply different pressures to the first region, the second region, and the third region, respectively.

6. The pattern transfer device of claim 5, wherein the first pressure member, the second pressure member, and the third pressure member apply pressure to the printing plate in a direction from the printing plate stage to the printing plate.

7. The pattern transfer device of claim 5, wherein when a surface height of the first region of the printing plate is higher than a surface height of the second region of the printing plate and when the surface height of the second region of the printing plate is higher than a surface height of the third region of the printing plate, a pressure applied by the third pressure member is greater than a pressure applied by the second pressure member and the pressure applied by the second pressure member is greater than a pressure applied by the first pressure member.

8. A pattern transfer method, comprising:
disposing a printing plate on a printing plate stage, the printing plate comprising a pattern;
measuring a flatness of the printing plate disposed on the printing plate stage;
changing, by using a pressure unit, the flatness of the printing plate by applying pressure to the printing plate disposed on the printing plate stage; and
transferring, to a substrate, the pattern formed on the printing plate having a changed flatness.

9. The method of claim 8, wherein measuring a flatness comprises measuring the flatness of the printing plate, determining at least one flatness profile of the printing plate according to the measured flatness, and defining at least one region according to the determined at least one flatness profile.

10. The method of claim 9, wherein changing the flatness comprises applying pressure to each of the at least one region of the printing plate.

11. The method of claim 10, wherein the at least one region of the printing plate comprises a first region having a first flatness profile, a second region having a second flatness profile, and a third region having a third flatness profile, each of the first flatness profile, the second flatness profile, and the third flatness profile has a different flatness profile, and a different pressure is applied to each of the first region, the second region, and the third region.

12. The method of claim 11, wherein the pressure unit comprises a first pressure member to apply pressure to the first region, a second pressure member to apply pressure to the second region, and a third pressure member to apply pressure to the third region, wherein the first pressure member, the second pressure member, and the third pressure member apply different pressures to the first region, the second region, and the third region, respectively.

13. The method of claim 12, wherein the first pressure member, the second pressure member, and the third pressure member are driven in a direction from the printing plate stage to the printing plate.

14. The method of claim 12, wherein when a surface height of the first region of the printing plate is higher than a surface height of the second region of the printing plate and when the surface height of the second region of the printing plate is higher than a surface height of the third region of the printing plate, the third pressure member applies a pressure greater than a pressure applied by the second pressure member and the pressure applied by the second pressure member is greater than a pressure applied by the first pressure member.

15. A pattern transfer device, comprising:
a printing plate stage on which a printing plate comprising a pattern is disposed;
a substrate stage on which a substrate is disposed, the pattern formed on the printing plate is to be printed on the substrate;
a pressure unit to apply pressure to the substrate, the pressure unit being disposed on the substrate stage; and
a printing unit to transfer the pattern formed on the printing plate to the substrate.

16. The pattern transfer device of claim 15, wherein the substrate stage is separated from the printing plate stage by a gap, and wherein the substrate comprises at least one region having at least one flatness profile, respectively, and the pressure unit applies pressure to each of the at least one region of the substrate.

17. The pattern transfer device of claim 16, wherein the pressure unit comprises a plurality of pressure members configured to deliver pressure to the at least one region of the substrate, respectively.

18. The pattern transfer device of claim 17, wherein the at least one region of the substrate comprises a first region having a first flatness profile, a second region having a second flatness profile, and a third region having a third flatness profile, each of the first flatness profile, the second flatness profile, and the third flatness profile has a different flatness profile, and the pressure unit applies a different pressure to each of the first region, the second region, and the third region.

19. The pattern transfer device of claim 18, wherein the pressure members comprise a first pressure member to apply pressure to the first region, a second pressure member to apply pressure to the second region, and a third pressure member to apply pressure to the third region, wherein the first pressure member, the second pressure member, and the third pressure member apply different pressures to the first region, the second region, and the third region, respectively.

20. The pattern transfer device of claim 19, wherein the first pressure member, the second pressure member, and the third pressure member are driven in a direction from the printing plate stage to the substrate.

21. The pattern transfer device of claim 19, wherein when a surface height of the first region of the substrate is higher than a surface height of the second region of the substrate and when the surface height of the second region of the substrate is higher than a surface height of the third region of the substrate, a pressure applied by the third pressure member is greater than a pressure applied by the second pressure member and the pressure applied by the second pressure member is greater than a pressure applied by the first pressure member.
